(19) United States
(12) Patent Application Publication
(10) Pub. No.: US 2006/0259618 A1
(43) Pub. Date: Nov. 16, 2006

(54) Method and apparatus of processing audio of multimedia playback terminal

(75) Inventor: Sung Lim Choi, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/435,263

(22) Filed: May 16, 2006

(30) Foreign Application Priority Data
May 16, 2005 (KR) 10-2005-0040894

(51) Int. Cl. G06F 15/16; G06F 15/173

(52) U.S. Cl. 709/224; 709/247

(57) ABSTRACT

An apparatus and method of processing audio are provided. In order to achieve synchronization between video and audio in a multimedia playback terminal, the apparatus of processing audio includes: a receiver storing audio data received through a wireless communications network, and providing audio data upon request; and a decoder decoding and outputting the audio data provided from the receiver, and outputting a silence signal when loss of the audio data occurs.

### CROSS-REFERENCE TO RELATED APPLICATIONS

Pursuant to 35 U.S.C. § 119(a), this application claims the benefit of earlier filing date and right of priority to Korean Application No. 10-2005-0040894, filed on May 16, 2005, the contents of which is hereby incorporated by reference herein in its entirety

### BACKGROUND OF THE INVENTION

1. Field of the Invention

The present invention relates to a method and apparatus of processing audio, and particularly, to a method and apparatus of processing audio capable of achieving synchronization between audio and video signals.

2. Description of the Related Art

With the development of a mobile communications technology, various multimedia services are being provided through personal mobile equipment. Also, various multimedia services including video on demand (VDO) and real-time video communication services, which had been provided through a wired communications network, are now being provided through a wireless communications network.

However, the wireless communications network is yet problematic in that traffic is fluid as compared to the wired communications network, and the connection quality varies depending on communication environments such as interference between networks, topography, natural features on the earth, etc.

Once the connection quality of a network is degraded regardless of whether the network is a wireless communications network or a wired communications network, loss of multimedia data occurs. That is, the degradation in connection quality of the network causes packet loss, and such packet loss degrades image and sound quality of a multimedia player such as a VOD player.

Particularly, unsynchronization between video and video signals, one example of the image and quality degradation, causes severe damage to the playback quality and reliability of a terminal.

In general, synchronization between video and audio in VOD players, etc is made with respect to audio playtime. However, when audio packet loss occurs due to the aforementioned various factors, the audio playtime lengthens rapidly.

For this reason, the video is also played back faster than normal, which creates a situation where the contents of a corresponding moving picture are incomprehensible to viewers.

### SUMMARY OF THE INVENTION

Accordingly, the present invention is directed to a method and apparatus of processing audio of a multimedia playback terminal that substantially obviates one or more problems due to limitations and disadvantages of the related art.

An object of the present invention is to provide a method and apparatus of processing audio capable of allowing playback of audio and video that are synchronized even when audio packet loss occurs.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method of processing audio, including: receiving audio data on packet basis through a multimedia service network; determining whether or not the received audio packet data is lost; decoding and converting the corresponding audio packet data into an analog audio signal when the determination results shows that the audio packet is a normal audio packet; and outputting silence in a playback section of the corresponding audio packet when the determination results shows that the audio packet loss occurs.

In another aspect of the present invention, there is provided an apparatus of processing audio, including: a receiver storing audio data received through a wireless communications network, and providing audio data upon request; and a decoder decoding and outputting the audio data provided from the receiver, and outputting a silence signal when loss of the audio data occurs.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a method of processing audio data through a wireless communications network;

FIG. 2 is view illustrating a method of processing a normal audio packet;

FIG. 3 is a view illustrating a method of processing audio when packet loss occurs according to the present invention; and

FIG. 4 is a view illustrating an apparatus of processing audio according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A method of synchronizing audio and video of a multimedia playback terminal according to the present invention will be described in detail with reference to accompanying drawings.

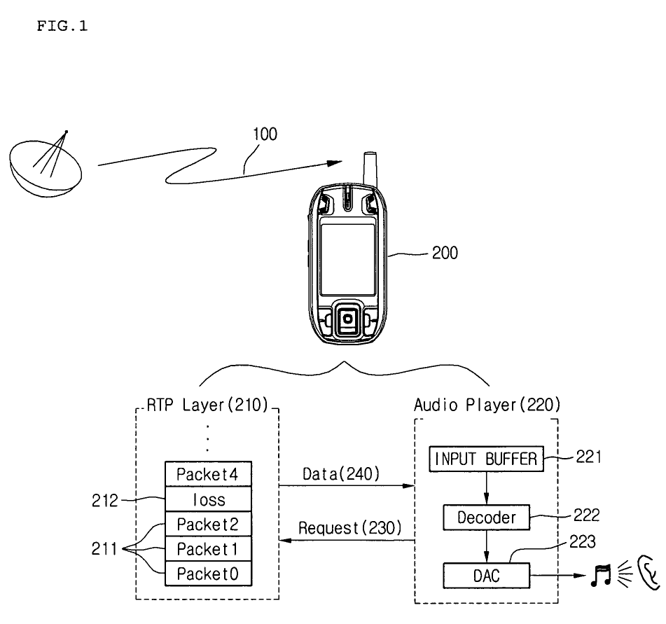

FIG. 1 is a view illustrating a method of processing audio streaming data through a wireless communications network.

A multimedia playback terminal 200 receives multimedia data on packet basis through a wireless communications network 100, decodes the received data, and outputs audio and video.

The multimedia playback terminal 200 includes a real time transport protocol (RTP) layer 210 for a real-time transport communication control, and an audio player 220.

The sequential order of processing audio data through the wireless communications network will now be described with reference to FIG. 1.

First, the multimedia playback terminal 200 receives audio data on packet basis through a wireless communications network 100. Then, the RTP layer 210 stores the received audio data on packet basis.

In order to play back the audio data received and stored in such a manner, the audio player 220 requests corresponding data from the RTP layer 210. That is, when the audio player 220 makes a request 230 for data from the RTP layer 210, the RTP layer 210 transmits corresponding audio data 240 to the audio player 220 by an FIFO method in the same order as the RTP layer 210 received the audio packets.

The audio packet transmitted to the audio player 220 from the RTP layer 210 is transmitted to a decoder 222 within the audio player 220 via an input buffer 221. The audio decoder 222 decodes the received corresponding audio packet data and configures the data into PCM data. Then, a digital/audio decoder 223 converts the corresponding PCM data into an analog audio signal and then outputs the analog audio signal through an audio output device such as a speaker, etc.

That is, in the audio player 220, when audio packet data is encoded using CODEC such as AAC, QCELP, EVRC, etc, the audio packet data is decoded into PCM data, the PCM data is converted into an analog signal through the digital/analog converter (DAC) 223, and then the analog signal is outputted through the audio output device such as a speaker.

The RTP layer 210 buffers a certain amount of audio packet data. Also, when a normal packet cannot be received due to environmental factors of the wireless communications network 100 and packet loss 212 occurs, the RTP layer 210 separately manages the number and size of the lost packet.

As described above, the audio playtime in receiving/decoding/converting and outputting the audio packet is determined by using time information contained in the audio packet.

However, when audio packet loss 212 occurs as illustrated in FIG. 1, the playtime information in the lost packet 212 is also lost. Therefore, the RTP layer 210 obtains the playtime information of the lost packet by calculation. That is, because the playtime of one packet is almost the same as that of the other packet containing contents having the identical sampling frequency thereto, the playtime of the lost audio packet may be approximately obtained.

Also, when data requested by the audio player 220 is lost, the RTP layer 210 notifies the audio player 220 that the data loss has occurred, and transmits information on the calculated playtime to the audio player 220.

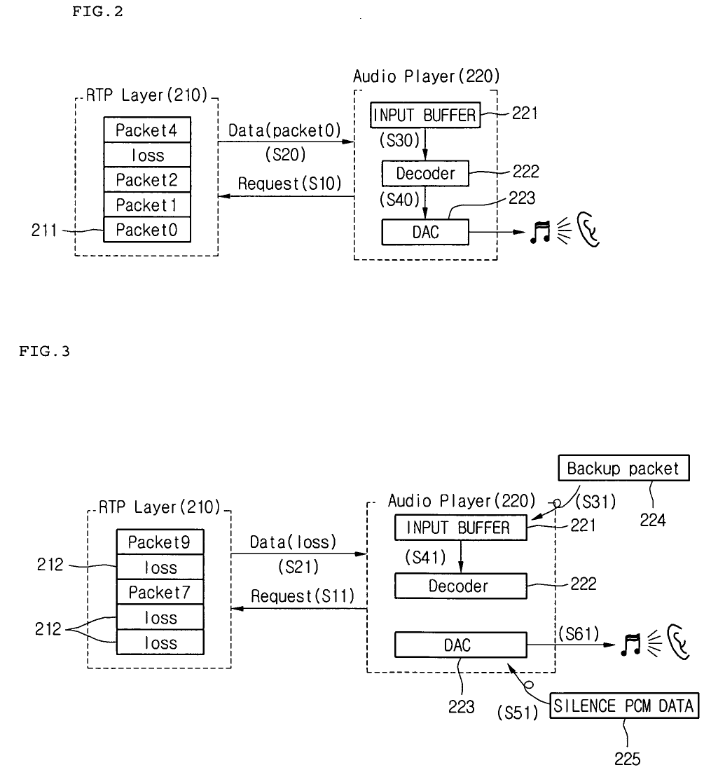

FIG. 2 is a view illustrating a process of processing a normal audio packet.

In a first operation (S10), the audio player 220 makes a request for audio data from the RTP layer 210.

In a second operation (S20), the RTP layer 210 receiving the request for audio data transmits a normal audio packet (e.g., packet 0) to the audio player 220. The audio player 220 copies the received audio packet (packet 0) in the input buffer 221.

In a third operation (S30), the decoder 222 receives the audio packet stored in the input buffer 221.

In a fourth operation (S40), the decoder 222 decodes the inputted audio packet (packet 0) to thereby obtain PCM data.

In a fifth operation (S50), the audio player 220 converts the audio data (PCM data) into an analog audio signal through the digital/analog converter (DAC) 223 and an audio CODEC chip, and outputs the converted signal through an audio output device such as a speaker. Here, the playtime is indicated using playtime information contained in the audio packet.

Such a series of operations are carried out sequentially on next audio packets (packet 1, 2, . . . ), thereby outputting audio data through the audio output device and indicating the required playtime information.

FIG. 3 is a view illustrating a process of processing a lost audio packet when audio packet loss occurs. That is, FIG. 3 illustrates a processing method in case of audio packet loss 212.

In a first operation (S11), the audio player 220 makes a request for audio data from the RTP layer 210.

Then, in a second operation (S21), the RTP layer 210 notifies the audio player 220 of the audio packet loss.

Then, the audio player 220 copies a normal packet (e.g. packet 0), which has been backed up, in the input buffer 221 of the decoder 222. That is, in a third operation (S31), the audio player 220 notified of the audio packet loss copies in the input buffer 221, an audio packet (backup packet) 224 previously backed up.

Then, in a fourth operation (S41), the backup packet data 224 is inputted to the decoder 222 from the input buffer 221.

In a fifth operation (S51), PCM data 225 outputted as silence (mute state), not PCM data outputted from the decoder 222, is copied in an input port of the digital/analog converter (DAC) 223. This is because the packet loss makes it impossible to exactly find out what kind of data was contained in the lost packet. In more detail, a packet just prior to the lost packet may be used in consideration of a correlation between packets, but if many packets are lost prior to a normal packet (e.g., packet 7) as illustrated in FIG. 3, audio signals outputted corresponding to the lost packets might be heard like noise. In this regard, the present invention employs a method of outputting silence for the lost packets because this method can be considered the most effective way to handle the packet loss.

Accordingly, in a sixth operation (S61), when the audio packet loss occurs, an analog audio signal is outputted as silence through the digital/analog converter (DAC) 223 and the audio CODEC chip to the audio output device such as a speaker. Also, the calculated playtime is transmitted from the RTP layer 210 so that the playtime can be indicated.

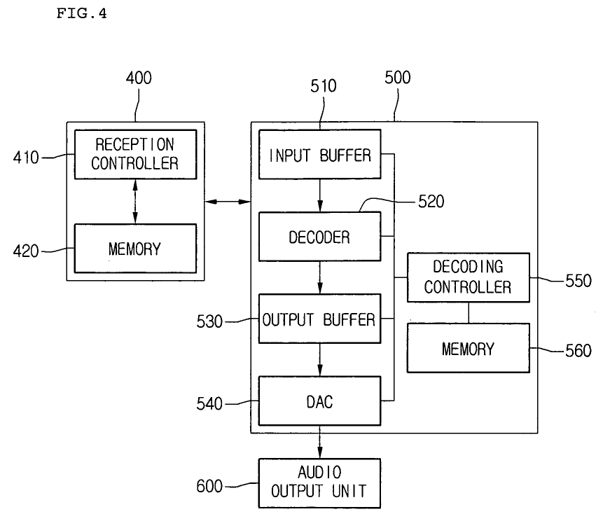

FIG. 4 is a view illustrating an apparatus of processing audio according to an embodiment of the present invention.

Referring to FIG. 4, the apparatus of processing audio according to an embodiment of the present invention includes a receiver 400 and a decoder 500.

When a multimedia playback terminal receives audio data, a reception controller 410 stores the audio packet on packet basis in a memory 420.

The reception controller 410 transmits audio data to an input buffer 510 of the decoder 500 upon request of the decoder 500. If audio data loss occurs, the reception controller 410 notifies a decoding controller 550 of the audio packet loss. That is, the reception controller 410 stores the number and size of the lost packet when the audio packet loss occurs, and calculates the playtime of the lost packet by using another packet having the same sampling frequency as the lost packet to transmit the playtime thereof to the decoding controller 550. The decoding controller 550 outputs silence during the playtime of the lost packet, and outputs time information to a video processor (not shown) so that the video processor can synchronize video with audio.

When receiving information on the audio packet loss, the decoding controller 550 transmits an audio packet previously backed up in a memory 560 to the input buffer 510.

The decoder 520 decodes the backup audio packet, and thus prevents an increase in audio playtime due to the audio packet loss.

The decoding controller 550 transmits PCM data outputted as silence to an output buffer 530, so that silence can be outputted at the time of packet loss.

The digital/analog converter (DAC) 540 converts audio data with respect to the lost audio packet into silence, and provides silence to an audio output unit 600.

In the present invention, when audio packet loss occurs, the lost audio packet is processed into outputted as silence. Accordingly, when synchronization between video and audio is made with respect to the audio playtime, a rapid increase in audio replay time is can be prevented, and an image is prevented from being played back faster than normal, thereby achieving the synchronization between the video and audio.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method of processing audio, the method comprising:
receiving audio data on packet basis through a multimedia service network;
determining whether or not the received audio packet data is lost;
decoding and converting the corresponding audio packet data into an analog audio signal when the determination results shows that the audio packet is a normal audio packet; and
outputting silence in a playback section of the corresponding audio packet when the determination results shows that the audio packet loss has occurred.

2. The method according to claim 1, wherein when the audio packet loss occurs, a normal audio packet previously backed up is provided to a decoder.

3. The method according to claim 1, wherein when the audio packet loss occurs, silence audio data is provided to a digital/analog converter instead of decoder output, and thus silence is outputted in a playback section of the corresponding audio packet.

4. The method according to claim 1, wherein information on whether or not the audio packet loss occurs is provided to an audio player port from an RTP layer.

5. The method according to claim 1, wherein lost time information is recovered by calculating in the RTP layer, playtime information corresponding to the lost audio packet and providing the information to an audio player port.

6. An apparatus of processing audio, comprising:
a receiver storing audio data received through a wireless communications network, and providing audio data upon request; and
a decoder decoding and outputting the audio data provided from the receiver, and outputting a silence signal when loss of the audio data occurs.

7. The apparatus according to claim 6, wherein the receiver comprises:
a memory storing the audio data on packet basis; and
a reception controller transmitting to the decoder, the audio data and information on a lost audio packet.

8. The apparatus according to claim 6, wherein the decoder comprises:
an input buffer receiving audio data from the receiver;
a decoder decoding the audio data of the input buffer,
a digital/analog converter digital/analog converting PCM data decoded by the decoder, and
a decoding controller controlling the input buffer, the decoder, and the digital/analog converter.

9. The apparatus according to claim 8, wherein when audio packet loss occurs, the decoding controller transmits backup audio packet to the input buffer.

10. The apparatus according to claim 8, wherein when audio packet loss occurs, the decoding controller inputs PCM data outputted as silence to the digital/analog converter.

11. The apparatus according to claim 10, further comprising an output buffer receiving and providing the PCM data outputted as silence to the digital/analog converter.

12. A method of processing audio, the method comprising:
receiving audio data on packet basis through a wireless communications network;
determining whether or not the audio data is lost; and
outputting a silence signal when the audio data is lost by decoding another audio data previously backed up instead of the lost audio data.

13. The method according to claim 12, further comprising inputting PCM data having a silence signal to a digital/analog converter when the audio data is lost.
